(19) United States
(12) Patent Application Publication
(10) Pub. No.: US 2013/0012064 A1
(43) Pub. Date: Jan. 10, 2013

(54) CONNECTOR FOR CLAMPING A COAXIAL CABLE

(75) Inventor: Adam Thomas Nugent, Canastota, NY (US)

(73) Assignee: JOHN MEZZALINGUA ASSOCIATES, INC., East Syracuse, NY (US)

(21) Appl. No.: 13/178,488

(22) Filed: Jul. 7, 2011

(51) Int. Cl. H01R 9/05; H01B 13/20

(52) U.S. Cl. 439/585; 29/828

(57) ABSTRACT

A connector including a main body having a first end and a second end, the main body configured to receive a prepared coaxial cable, a front body operably attached to the main body, and an outer conductor engagement member having a first end and a second end, the outer conductor engagement member having at least one axial slot to permit deflection of the outer conductor engagement member, wherein deflection of the outer conductor engagement member clamps the coaxial cable. Furthermore, an outer conductor engagement member and an associated method are also provided.

### FIELD OF TECHNOLOGY

The following relates to connectors used in coaxial cable communications, and more specifically to embodiments of a connector having improved clamping of a coaxial cable.

### BACKGROUND

Connectors for coaxial cables are typically connected to complementary interface ports or corresponding connectors to electrically integrate coaxial cables to various electronic devices, including ports on cell towers. Coaxial cable typically includes an inner conductor, an insulating layer surrounding the inner conductor, an outer conductor surrounding the insulating layer, and a protective jacket surrounding the outer conductor. Each type of coaxial cable has a characteristic impedance which is the opposition to signal flow in the coaxial cable. The impedance of a coaxial cable depends on its dimensions and the materials used in its manufacture. For example, a coaxial cable can be tuned to a specific impedance by controlling the diameters of the inner and outer conductors and the dielectric constant of the insulating layer. All of the components of a coaxial system should have the same impedance in order to reduce internal reflections at connections between components. Such reflections increase signal loss and can result in the reflected signal reaching a receiver with a slight delay from the original.

Two sections of a coaxial cable in which it can be difficult to maintain a consistent impedance are the terminal sections on either end of the cable to which connectors are attached. For example, the attachment of some field-installable compression connectors requires the removal of a section of the insulating layer at the terminal end of the coaxial cable in order to insert a support structure of the compression connector between the inner conductor and the outer conductor. The support structure of the compression connector prevents the collapse of the outer conductor when the compression connector applies pressure to the outside of the outer conductor. Unfortunately, however, the dielectric constant of the support structure often differs from the dielectric constant of the insulating layer that the support structure replaces, which changes the impedance of the terminal ends of the coaxial cable. This change in the impedance at the terminal ends of the coaxial cable causes increased internal reflections, which results in increased signal loss.

Another difficulty with field-installable connectors, such as compression connectors or screw-together connectors, is maintaining acceptable levels of passive intermodulation (PIM). PIM in the terminal sections of a coaxial cable can result from nonlinear and insecure contact between surfaces of various components of the connector. A nonlinear contact between two or more of these surfaces can cause micro arcing or corona discharge between the surfaces, which can result in the creation of interfering RF signals. For example, some screw-together connectors are designed such that the contact force between the connector and the outer conductor is dependent on a continuing axial holding force of threaded components of the connector. Over time, the threaded components of the connector can inadvertently separate, thus resulting in nonlinear and insecure contact between the connector and the outer conductor.

Where the coaxial cable is employed on a cellular communications tower, for example, unacceptably high levels of PIM in terminal sections of the coaxial cable and resulting interfering RF signals can disrupt communication between sensitive receiver and transmitter equipment on the tower and lower-powered cellular devices. Disrupted communication can result in dropped calls or severely limited data rates, for example, which can result in dissatisfied customers and customer churn.

Current attempts to solve these difficulties with field-installable connectors generally consist of employing a pre-fabricated jumper cable having a standard length and having factory-installed soldered or welded connectors on either end. These soldered or welded connectors generally exhibit stable impedance matching and PIM performance over a wider range of dynamic conditions than current field-installable connectors. These pre-fabricated jumper cables are inconvenient, however, in many applications.

For example, each particular cellular communication tower in a cellular network generally requires various custom lengths of coaxial cable, necessitating the selection of various standard-length jumper cables that is each generally longer than needed, resulting in wasted cable. Also, employing a longer length of cable than is needed results in increased insertion loss in the cable. Further, excessive cable length takes up more space on the tower. Moreover, it can be inconvenient for an installation technician to have several lengths of jumper cable on hand instead of a single roll of cable that can be cut to the needed length. Also, factory testing of factory-installed soldered or welded connectors for compliance with impedance matching and PIM standards often reveals a relatively high percentage of non-compliant connectors. This percentage of non-compliant, and therefore unusable, connectors can be as high as about ten percent of the connectors in some manufacturing situations. For all these reasons, employing factory-installed soldered or welded connectors on standard-length jumper cables to solve the above-noted difficulties with field-installable connectors is not an ideal solution.

Accordingly, during movement of the connector and its internal components when mating with a port, the conductive components may break contact with other conductive components of the connector or conductors of a coaxial cable, causing undesirable passive intermodulation (PIM) results. For instance, the contact between a center conductor of a coaxial cable and a receptive clamp is critical for desirable passive intermodulation (PIM) results. Likewise, poor clamping of the coaxial cable within the connector allows the cable to displace and shift in a manner that breaks contact with the conductive components of the connector, causing undesirable PIM results. Furthermore, poor clamping causes a great deal of strain to the connector.

Thus, a need exists for an apparatus and method for a connector that provides efficient clamping of the coaxial cable.

### SUMMARY

A first general aspect relates to an outer conductor engagement member comprising: an annular member having a first end and a second end, the annular member including an annular recessed portion proximate the first end, wherein the annular member is disposed within a main body of a coaxial cable connector, and at least one axial opening on the annular member extending in a first direction from proximate the second end through the first end to facilitate radially inward deflection of the annular recessed portion to compress a coaxial cable jacket of a received coaxial cable.

A second general aspect relates to a connector comprising: a main body having a first end and a second end, the main body configured to receive a prepared coaxial cable, a compression member configured for axial movable engagement with the main body, and an outer conductor engagement member having a first end and a second end, the outer conductor engagement member having at least one axial slot to permit deflection of the outer conductor engagement member, wherein deflection of the outer conductor engagement member clamps the coaxial cable.

A third general aspect relates to a connector comprising: a main body having a first end and a second end, the main body configured to receive a prepared coaxial cable, a compression member configured for axial movable engagement with the main body, and a means to clamp the coaxial cable and an outer conductor of the coaxial cable, wherein the means is operable via axial compression of the compression member.

A fourth general aspect relates to a method of clamping a coaxial cable, comprising providing a connector including: a main body having a first end and a second end, the main body configured to receive a prepared coaxial cable, a compression member configured for axial movable engagement with the main body, and an outer conductor engagement member having a first end and a second end; and slotting the outer conductor engagement member to facilitate deflection of the outer conductor engagement member to clamp the coaxial cable.

A fifth general aspect relates to a device configured to be operably affixed to a coaxial cable comprising a compression connector, wherein the compression connector is configured to attach to the cable by the compression of at least one axially slidably movable component of the connector, wherein the compression connector achieves an intermodulation level below −155 dBc.

A sixth general aspect relates to a coaxial cable connector comprising a main body configured to receive a coaxial cable, a compression member configured for axial movable engagement with the main body, an outer conductor engagement member having an annular recessed portion, wherein deflection of the outer conductor engagement member clamps the coaxial cable, and a cover disposed over at least a portion of the connector to seal the connector against environmental elements.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a cross-sectional view of a first embodiment of a connector in an open position;

FIG. 2A depicts a cut-away perspective view of an embodiment of a coaxial cable;

FIG. 2B depicts a perspective view of an embodiment of the coaxial cable;

FIG. 3 depicts a perspective view of an embodiment of a main body of the connector;

FIG. 4 depicts a perspective view of an embodiment of a front body of the connector;

FIG. 5 depicts a perspective view of an embodiment of an outer conductor engagement member;

FIG. 6 depicts a cross-sectional view of the first embodiment of the connector in a closed position;

FIG. 7 depicts a cross-sectional view of a second embodiment of a connector in an open position;

FIG. 8 depicts a cross-sectional view of the second embodiment of the connector in a closed position;

FIG. 9 depicts a first view of a chart showing a performance of an embodiment of the first and second embodiments of the connector;

FIG. 10 depicts a perspective view of an embodiment of a coaxial cable connector having a cover in a first position; and

FIG. 11 depicts a perspective view of an embodiment of the coaxial cable connector having a cover in a second, sealing position

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

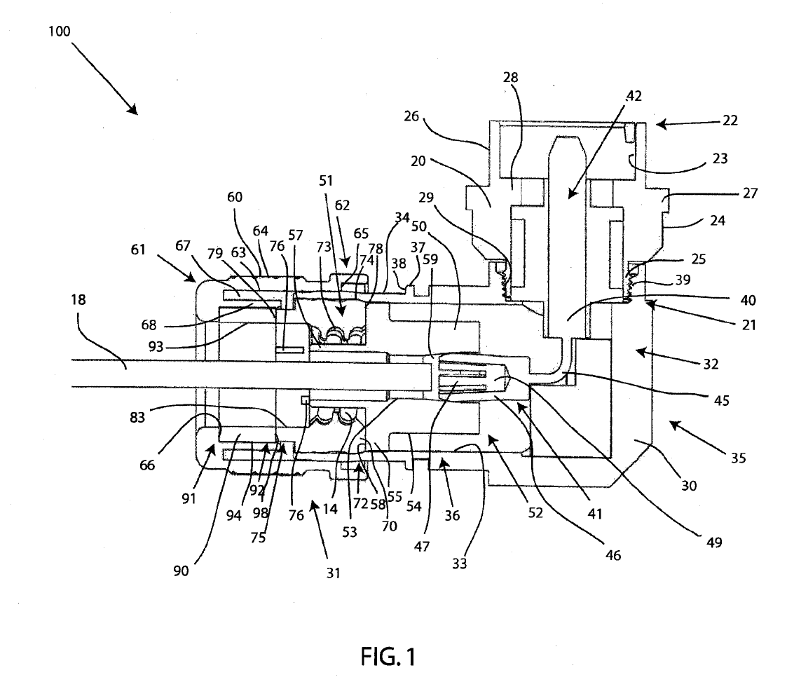

Referring to the drawings, FIG. 1 depicts an embodiment of a connector 100. Connector 100 may be a straight connector, a right angle connector, an angled connector, an elbow connector, or any complimentary connector that may receive a center conductor 18 of a coaxial cable. Further embodiments of connector 100 may receive a center conductor 18 of a coaxial cable 10, wherein the coaxial cable 10 includes a corrugated, smoothwall, or otherwise exposed outer conductor 14. Connector 100 can be provided to a user in a preassembled configuration to ease handling and installation during use. Two connectors, such as connector 100 may be utilized to create a jumper that may be packaged and sold to a consumer. A jumper may be a coaxial cable 10 having a connector, such as connector 100, operably affixed at one end of the cable 10 where the cable 10 has been prepared, and another connector, such as connector 100, operably affixed at the other prepared end of the cable 10. Operably affixed to a prepared end of a cable 10 with respect to a jumper includes both an uncompressed/open position and a compressed/closed position of the connector while affixed to the cable. For example, embodiments of a jumper may include a first connector including components/features described in association with connector 100, and a second connector that may also include the components/features as described in association with connector 100, wherein the first connector is operably affixed to a first end of a coaxial cable 10, and the second connector is operably affixed to a second end of the coaxial cable 10. Embodiments of a jumper may include other components, such as one or more signal boosters, molded repeaters, and the like.

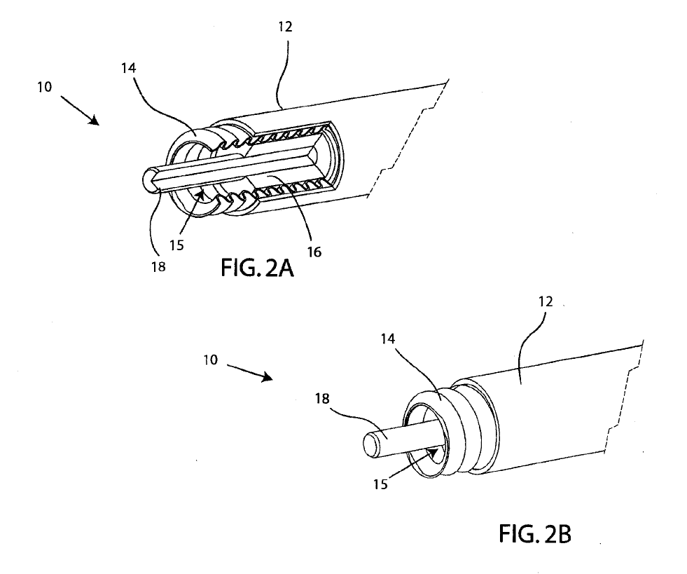

Referring to FIGS. 2A and 2B, embodiments of a coaxial cable 10 may be securely attached to a coaxial cable connector. The coaxial cable 10 may include a center conductor 18, such as a strand of conductive metallic material, surrounded by an interior dielectric 16; the interior dielectric 16 may possibly be surrounded by an outer conductor 14; the outer conductor 14 is surrounded by a protective outer jacket 12, wherein the protective outer jacket 12 has dielectric properties and serves as an insulator. The outer conductor 14 may extend a grounding path providing an electromagnetic shield about the center conductor 18 of the coaxial cable 10. The outer conductor 14 may be a semi-rigid outer conductor of the coaxial cable 10 formed of conductive metallic material, and may be corrugated or otherwise grooved. For instance, the outer conductor 14 may be smooth walled, annularly ribbed, spiral corrugated, or helical corrugated. The coaxial cable 10 may be prepared by removing a portion of the protective outer jacket 12 and coring out a portion of the dielectric 16 to expose the outer conductor 14 and create a cavity 15 or space between the outer conductor 14 and the center conductor 18. The protective outer jacket 12 can physically protect the various components of the coaxial cable 10 from damage that may result from exposure to dirt or moisture, and from corrosion. Moreover, the protective outer jacket 12 may serve in some measure to secure the various components of the coaxial cable 10 in a contained cable design that protects the cable 10 from damage related to movement during cable installation. The outer conductor 14 can be comprised of conductive materials suitable for carrying electromagnetic signals and/or providing an electrical ground connection or electrical path connection. Various embodiments of the outer conductor layer 14 may be employed to screen unwanted noise. The dielectric 16 may be comprised of materials suitable for electrical insulation. The protective outer jacket 12 may also be comprised of materials suitable for electrical insulation. It should be noted that the various materials of which all the various components of the coaxial cable 10 should have some degree of elasticity allowing the cable 10 to flex or bend in accordance with traditional broadband communications standards, installation methods and/or equipment. It should further be recognized that the radial thickness of the coaxial cable 10, protective outer jacket 12, outer conductor 14, interior dielectric 16, and/or center conductor 18 may vary based upon generally recognized parameters corresponding to broadband communication standards and/or equipment.

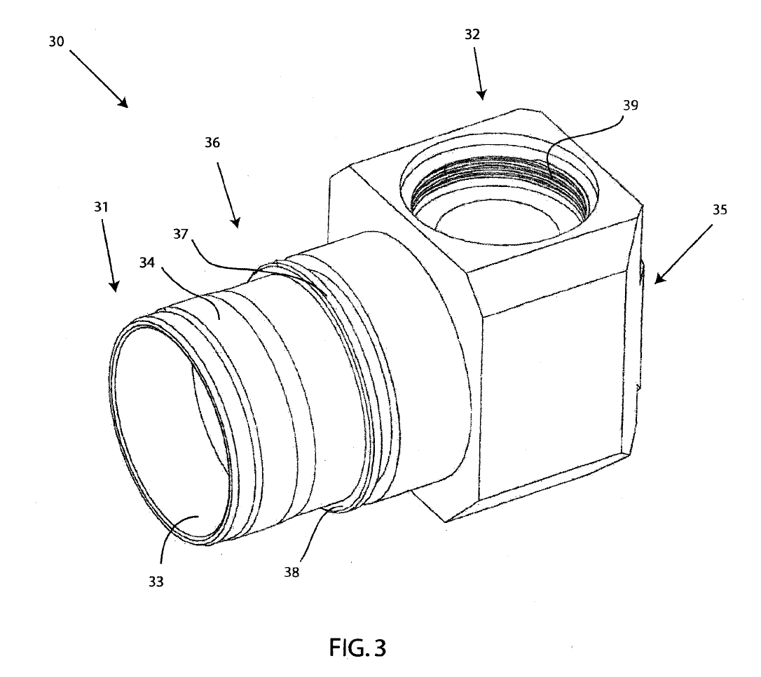

Referring now to FIGS. 1 and 3, embodiments of connector 100 may include a main body 30, a front body 20, a contact 40, an insulator body 50, an outer conductor engagement member 70, a collar 90, and a compression member 60. Further embodiments of connector 100 may include connector comprising a main body 30 having a first end 31 and a second end 32, the main body 30 configured to receive a prepared coaxial cable 10, a front body 20 operably attached to the main body 30, and an outer conductor engagement member 70 having a first end 71 and a second end 72, the outer conductor engagement member 70 having at least one axial slot 76 to permit deflection of the outer conductor engagement member 70, wherein deflection of the outer conductor engagement member 70 clamps the coaxial cable 10.

Embodiments of connector 100 may include a main body 30. Main body 30 may include a first end 31, a second end 32, an inner surface 33, and an outer surface 34. Main body 30 may further include a first portion 35 and a second portion 36. The first portion 35 of the main body 30 may be proximate the second end 32, and may have a generally axial opening in a longitudinal, or substantially longitudinal, direction. Embodiments of the first portion 35 of the main body 30 may also include a threaded portion 39 for threadably engaging, or securably retaining, a front body 20. The threaded portion 39 may be internal or interior female threads having a pitch and depth that correspond to external or exterior threads 29 of the front body 20. The second portion 36 of the main body 30 may extend from the first portion 35, and may be structurally integral with the first portion 35, or may be structurally independent (e.g. utilization of a coupling means) of the first portion 35 of the main body 30. Moreover, the second portion 36 may have a generally axial opening in a latitudinal, or substantially latitudinal, direction. The generally axial opening of the second portion 36 may extend from proximate the first end 31 and may be in communication with the generally axial opening of the first portion 35. The opening of the main body 30, or the second portion 36 of the main body 30, may include narrowing geometry to compress squeeze the outer conductor engagement member 70, causing deflection of the outer conductor engagement member 70 to clamp the outer conductor 14 and the cable 10. For example, the opening within the main body 30 may taper gradually, causing the inner diameter to gradually decrease from the first end 31 to the second end 32 of the main body. Alternatively, the inner surface 33 of the main body may have a surface feature, such as a protrusion, ramped portion, bump, annular barb, and the like, that narrows the opening within the main body 30 to compress the slotted outer conductor engagement member 70. The generally axial opening of the second portion 36 of the main body 30 may have an internal diameter large enough to allow an insulator body 50, an outer conductor engagement member 70, a collar 90, and portions of a coaxial cable 10 to enter and remain disposed within the main body 30 while operably configured; however, the opening within the second portion 36 may decrease in diameter gradually or at one or more points to compress the outer conductor engagement member 70. In other words, the outer conductor engagement member 70 and other internal components may be radially compressed by the inner surface 33 of the main body 30 as the components are driven axially along within the main body 30. Furthermore, embodiments of the main body 30 may include an annular protrusion 37 which may protrude or extend a distance from the outer surface 34 of the main body 30; the annular protrusion 37 may be disposed around the second portion 36 of the main body 30. The annular protrusion 37 may include a mating edge 38 (i.e. a face/side of the annular protrusion 37 which faces the first end 31 of the main body 30) that can mate with a mating edge, such as annular recessed portion 65 of a compression member 60 while in a closed position. In addition, the main body 30 may be formed of metals or polymers or other materials that would facilitate a rigidly formed body. Manufacture of the main body 30 may include casting, extruding, cutting, turning, tapping, drilling, injection molding, blow molding, or other fabrication methods that may provide efficient production of the component. Those in the art should appreciate that various embodiments of the main body 30 may also comprise various inner or outer surface features, such as annular grooves, detents, tapers, recesses, and the like, and may include one or more structural components having insulating properties located within the main body 30.

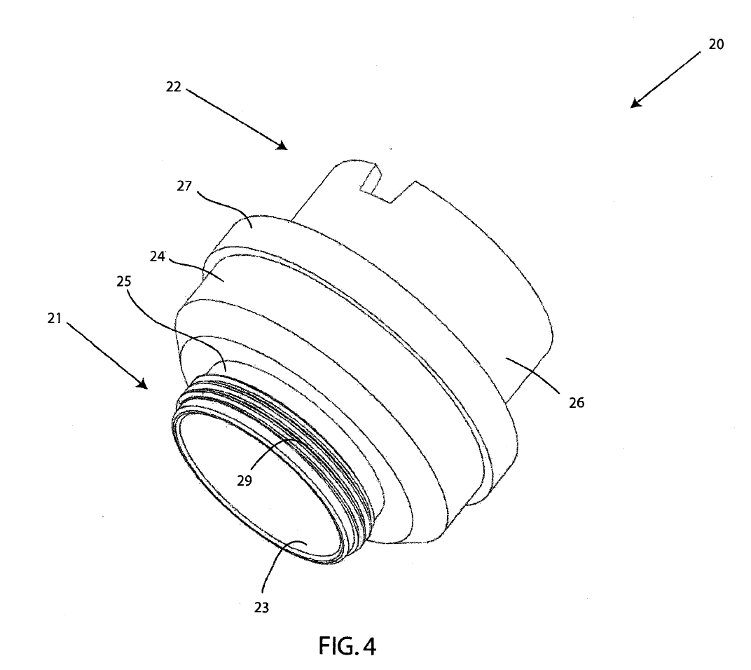

Referring still to FIG. 1, and with additional reference to FIG. 4, embodiments of connector 100 may include a front body 20. The front body 20 may include a first end 21, a second end 22, an inner surface 23, and an outer surface 24. Embodiments of the front body 20 may be a coupling member configured to mate with a corresponding port, or other connector; the front body 20 may include threads proximate the second end 22 to threadably mate with a port. The front body 20 may include a generally axial opening extending from the first end 21 to the second end 22. Proximate or otherwise near the first end 21 of the front body 20 may be an annular detent 25. The annular detent 25 may be sized and dimensioned to fit within the generally axial opening of the first portion 35 of the main body 30. Disposed on the outer surface of the annular detent 25 may be a threaded portion 29 for threadably engaging, or securably affixing to, the main body 30. In other words, the front body 20 may be coupled to the main body 30. The threaded portion 29 may be external or exterior threads having a pitch and depth that correspond to internal or interior female threads of the front body 20. Moreover, the front body 20 may include an annular recessed portion 26 proximate or otherwise near the second end 22. The annular recessed portion 26 may create a flange 27 extending annularly around the front body 20. Embodiments of the front body 20 may also include an internal protrusion 28 which may protrude or extend a distance from the inner surface 23 of the front body 20. In addition, the front body 20 may be formed of metals or polymers or other materials that would facilitate a rigidly formed body. Manufacture of the front body 20 may include casting, extruding, cutting, turning, tapping, drilling, injection molding, blow molding, or other fabrication methods that may provide efficient production of the component. Those in the art should appreciate that various embodiments of the front body 20 may also comprise various inner or outer surface features, such as annular grooves, detents, tapers, recesses, and the like, and may include one or more structural components having insulating properties located within the front body 20.

With continued reference to FIG. 1, embodiments of connector 100 may include a contact 40. Contact 40 may include a first end 41 and a second end 42. Further embodiments of connector 100 may include a contact 40 wherein a portion of the contact 40 may be disposed within the main body 30, and another portion may be disposed within the front body 20. Contact 40 may be a conductive element that may extend or carry an electrical current and/or signal from a first point to a second point. Contact 40 may be a terminal, a pin, a conductor, an electrical contact, a curved contact, a bended contact, an angled contact, and the like. Contact 40 may further include a connection portion 45 that may connect, or otherwise be disposed between, the first end 41 and the second end 42; the connection portion 45 may be structurally integral with the other portions of contact 40. Contact 40 may have various diameters, sizes, and may be arranged in any alignment throughout the connector 100, depending on the shape or orientation of the connection portion 45. For example, embodiments of connection portion 45 may be curved or otherwise non-linear in shape to achieve a curve-shaped contact 40. Further embodiments of contact 40 may include a bended or curved connection portion 45 to from a contact 40 that forms a right angle (i.e. 90), or a substantially right angle. Furthermore, contact 40 may be both female and male. The male electrical contacts may include spikes, or similar pointed protrusion, which may be configured to insert into a center conductor of a corresponding connector. In contrast, the female electrical contact may include sockets, or similar receptacle, which may be configured to receive an exposed, protruding center conductor, such as center conductor 18. Thus, electrical contact 40 may include a socket element at one end to receive, and a spike or similar element at the opposing end. The contact 40, including the connection portion 45 of the contact 40 should be formed of conductive materials.

Moreover, embodiments of contact 40 may include a socket 46 proximate or otherwise near the first end 41. The socket 46 may be a conductive center conductor clamp or basket that clamps, grips, collects, or mechanically compresses onto the center conductor 18. The socket 46 may further include an opening 49, wherein the opening 49 may be a bore, hole, channel, and the like, that may be tapered. The socket 46, in particular, the opening 49 of the socket 46 may accept, receive, and/or clamp an incoming center conductor 18 of the coaxial cable 10 as a coaxial cable 10 is further inserted into the main body 30 to achieve a closed position. The socket 46 may include a plurality of engagement fingers 47 that may permit deflection and reduce (or increase) the diameter or general size of the opening 49. In other words, the socket 46 of contact 40 may be slotted or otherwise resilient to permit deflection of the socket 46 as the coaxial cable 10 is further inserted into the main body 30 to achieve a closed position, or as the compression member 60 is axially displaced further onto main body 30.

Referring still to FIG. 1, embodiments of connector 100 may include an insulator body 50. The insulator body 50 may include a first end 51, a second end 52, an internal surface 53, and an outer surface 54. The insulator body 50 may be disposed within the main body 30. For example, the insulator body 50 may be disposed or otherwise located in the generally axial opening of the second portion 36 of the main body 30. The insulator body 50 may further include an opening 59 extending axially through the insulator body 50 from the first end 51 to the second end 52. The opening 59 may be a bore, hole, channel, tunnel, and the like, that may accept, receive, accommodate, etc., an incoming center conductor 18 of the coaxial cable 10 as a coaxial cable 10 is further inserted into the main body 30. The diameter or general size of the opening 59 should be large enough to accept the center conductor 18 of the coaxial cable 10, and may be approximately the same diameter or general size of the socket 46 of contact 40. Moreover, embodiments of the insulator body 50 may include an annularly extending protrusion 55 which may protrude or extend a distance from the outer surface 54 of the insulator body 50. The diameter of the flange 55 may be substantially the same or slightly smaller than the diameter of the generally axial opening of the second portion 36 of the main body 30 to allow axial displacement of the insulator body 50 within the main body 30. The annular protrusion 55 may include a mating edge 58 (i.e. a face/side of the annular protrusion 55 which faces the first end 51 of the insulator body 50) that can mate with a mating edge 78 of an outer conductor engagement member 70, and a portion of the outer conductor 14 as the coaxial cable 10 is advanced through the main body 30. Further embodiments of the insulator body 50 may include an annular detent 57 proximate or otherwise near the first end 51 of the insulator body 50. The annular detent 57 may be sized and dimensioned to enter cavity 15 of the coaxial cable 10, wherein the cavity 15 is created when a portion of the dielectric 16 surrounding the center conductor 18 is removed or cored. The annular detent 57 may engage the dielectric 16, in particular a mating edge of the dielectric as the cable 10 is advanced into the main body 30. Thus, the annular detent 57 of the insulator body 50 may be disposed between the outer conductor 14 and the center conductor 18 in a closed position. Furthermore, the insulator body 50 should be made of non-conductive, insulator materials. Manufacture of the insulator body 50 may include casting, extruding, cutting, turning, drilling, compression molding, injection molding, spraying, or other fabrication methods that may provide efficient production of the component.

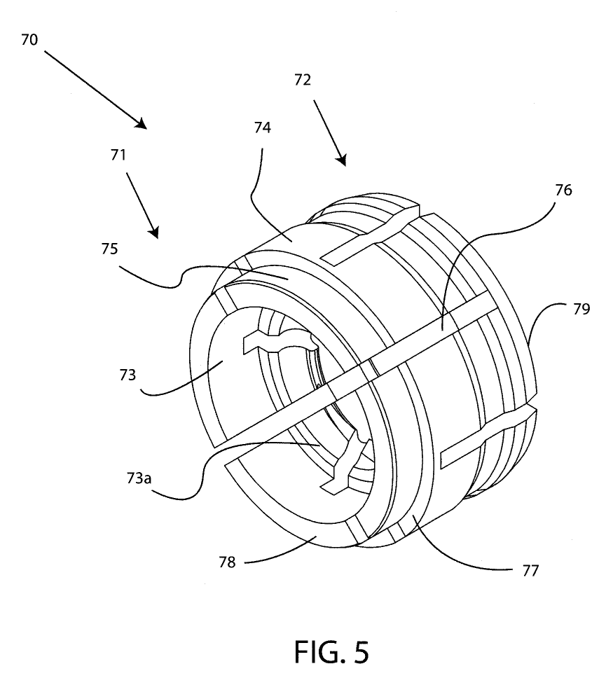

Referring again to FIG. 1 and with additional reference to FIG. 5, embodiments of connector 100 may include an outer conductor engagement member 70. Embodiments of the outer conductor engagement member 70 may be a clamp, a clamp driver, a seal driver, or any generally annular member configured to compress and/or clamp a coaxial cable 10 and an outer conductor 14. For example, embodiments of the outer conductor engagement member 70 may be an annular member having a first end 71 and a second end 72, the annular member including an annular recessed portion 75 proximate the first end 71, wherein the annular member is disposed within a main body 30 of a coaxial cable connector 100, and at least one axial opening 76 on the annular member extending in a first direction from proximate the second end 72 through the first end 71 to facilitate radially inward deflection of the annular recessed portion 75 to compress a coaxial cable jacket 12 of a received coaxial cable 10. The outer conductor engagement member 70 may include a first end 71, a second end 72, an inner surface 73, and an outer surface 74. Embodiments of the outer conductor engagement member 70 may have an outer diameter that allows insertion within the main body 30 proximate the first end 31 (but compresses as it is driven toward the second end 32). Because the outer conductor engagement member 70 may be slotted (described infra), the outer conductor engagement member 70 may be radially compressed inward to clamp the cable 10 and outer conductor 14 due to the internal geometry of the opening of the main body 30. Proximate the first end 71, the outer conductor engagement member 70 may include an annular recessed portion 75 configured to surround or substantially surround the outer cable jacket 12 while operably configured. The annular recessed portion 75 of the outer conductor engagement member 70 may define a portion of the outer conductor engagement member 70 having a reduced outer diameter. The annular recessed portion 75 may be an extension of the outer conductor engagement member 70, providing a surface for gripping/securing during a machining process, which can be helpful when machining an outer conductor engagement member having a spiral, helical, or ribbed inner surface portions.

Moreover, the outer conductor engagement member 70 may be slotted to permit deflection to clamp and/or compress the coaxial cable 10 within the connector 100, including the jacket 12 and the outer conductor 14. For instance, the outer conductor engagement member 70 may include one or more openings 76 to permit/facilitate radial deflection of the outer conductor engagement member 70 onto the cable jacket 12 and the outer conductor 14. Embodiments of the axial openings 76 may be opening, slots, channels, keyways, and the like. At least one axial opening 76 may axially extend from proximate the second end 72 towards and through the first end 71 to facilitate inward (and outward) flex of the outer conductor engagement member 70 proximate the annular recessed portion 75 to pinch the cable jacket 12. In other words, the deflection of the outer conductor engagement member 70 proximate the annular recessed portion 75 may compress onto and clamp the coaxial cable 10 via the inner surface 73 of the annular recessed portion 75 physically engaging the cable jacket 12. Likewise, at least one axial opening 76 may axially extend from proximate the first end 71 towards and through the second end 72 to facilitate inward (and outward) flex of the outer conductor engagement member 70 proximate the second end 72 to clamp or otherwise seize the rigid outer conductor layer 14. Accordingly, the outer conductor engagement member 70 may clamp or otherwise seize the cable 10, including both the cable jacket 12 and/or the outer conductor 14 to support and retain the connector 100, which can provide stability to the moving components of the connector 100 to avoid undesirable PIM results (i.e. prevent nonlinear and insecure contact between surfaces of various components of the connector).

The outer conductor engagement member 70 may be disposed within the main body 30 proximate or otherwise near the insulator body 50. For instance, the outer conductor engagement member 70 may be disposed between the collar 90 and the insulator body 50. Moreover, the outer conductor engagement member 70 may be disposed around the outer conductor layer 14, wherein the inner surface 73 may engage, threadably or otherwise, the outer conductor 14 and the cable jacket 12 in a closed position. The inner surface 73 may include a grooved portion 73a proximate the second end 72 of the outer conductor engagement member 70, wherein the grooved portion 73a corresponds to an outer surface of the outer conductor layer 14. Embodiments of the outer conductor engagement member 70 may include a grooved portion 73a of the inner surface 73 with threads or grooves that correspond with a helical corrugated outer conductor. Other embodiments of the outer conductor engagement member 70 may include grooved portion 73a of the inner surface 73 with threads or grooves that correspond with a spiral corrugated outer conductor. Further embodiments of the outer conductor engagement member 70 may include an inner surface 73 that suitably engages a smooth wall outer conductor having no grooved portion. Furthermore, embodiments of the outer conductor engagement member 70 may include a first mating edge 78 proximate or otherwise near the second end 72, a second mating edge 79 and a third mating edge 77 proximate or otherwise near the first end 71. The first mating edge 78 may engage the mating edge 58 of the insulator body 50 as the coaxial cable 10 is further inserted into the axial opening of the main body 30. Similarly, the second mating edge 79 may engage a first mating edge 98 of the collar 90 as the coaxial cable is advanced through the main body 30 proximate the first end 31. The third mating edge 77 may engage an inner portion 68 of the compression member 60 as the connector moves to a closed position. Furthermore, the outer conductor engagement member 70 may be made of conductive materials. Manufacture of the outer conductor engagement member 70 may include casting, extruding, cutting, turning, drilling, compression molding, injection molding, spraying, or other fabrication methods that may provide efficient production of the component.

With reference still to FIG. 1, embodiments of connector 100 may include a collar 90. The collar 90 may include a first end 91, a second end 92, an inner surface 93, and an outer surface 94. The collar 90 may be a generally annular tubular member. The collar 90 may be a solid sleeve collar and may be disposed within the main body 30 proximate or otherwise near the outer conductor engagement member 70. For instance, collar 90 may be disposed around the cable jacket 12 of the coaxial cable 10 when the cable 10 enters the connector 100, which may form a seal around the cable 10. For instance, as the compression member 60 is axially compressed, the collar 90 may deform and sealingly engage the cable jacket 12 to prevent the ingress of environmental elements, such as rainwater. Further embodiments of the collar 90 may also include a mating edge 98 proximate or otherwise near the second end 92 that may engage the second mating edge 79 of the outer conductor engagement member 70 as the coaxial cable 10 is further inserted into the axial opening of the main body 30. Additionally, the collar 90 should be made of non-conductive, insulator materials, and can be made of elastomeric materials. Manufacture of the collar 90 may include casting, extruding, cutting, turning, drilling, compression molding, injection molding, spraying, or other fabrication methods that may provide efficient production of the component.

Embodiments of connector 100 may also include a compression member 60. The compression member 60 may have a first end 61, a second end 62, an inner surface 63, and an outer surface 64. The compression member 60 may be a generally annular member having a generally axial opening therethrough. The compression member 60 may be disposed over or around a portion of the main body 30. For instance, the compression member 60 may surround the second portion 36 of the main body 30. Proximate or otherwise near the second end 62, the compression member 60 may include an internal annular recessed portion 65. The internal annular recessed portion 65 may engage the mating edge 38 of the annular protrusion 37 of the main body 30 as the connector 100 moves from an open to a closed position. For instance, the compression member 60 may axially slide towards the second end 32 of the main body 30 until the internal recessed portion 65 physically or mechanically engages the annular protrusion 37 of the main body 30. Moreover, the compression member 60 may include an annular lip 66 proximate or otherwise near the first end 61. The annular lip 66 may be configured to engage the collar 90. The compression member 60 may further include a cavity 67 proximate or otherwise near the first end 61. The cavity 67 may be a space, opening, void, and the like, which may be located between the inner surface 63 of the compression member 60 and an inner portion 68. The inner portion 68 may be an annular member which can be parallel to the outer structural surface of the compression member 60. Embodiments of the inner portion 68 may be structurally integral with the compression member 60 and may extend a distance into the generally axially opening of the compression member 60, while maintaining a radial distance from the inner surface 63 of the compression member 60. The inner portion 68 may surround or substantially surround the cable jacket 12 of the coaxial cable 10 when the cable 10 is present in the connector. The cavity 67 may accommodate, receive, accept, etc., a portion of the main body 30 as the compression member 60 is axially displaced onto the main body 30. Furthermore, it should be recognized, by those skilled in the requisite art, that the compression member 60 may be formed of rigid materials such as metals, hard plastics, polymers, composites and the like, and/or combinations thereof. Furthermore, the compression member 60 may be manufactured via casting, extruding, cutting, turning, drilling, knurling, injection molding, spraying, blow molding, component overmolding, combinations thereof, or other fabrication methods that may provide efficient production of the component.

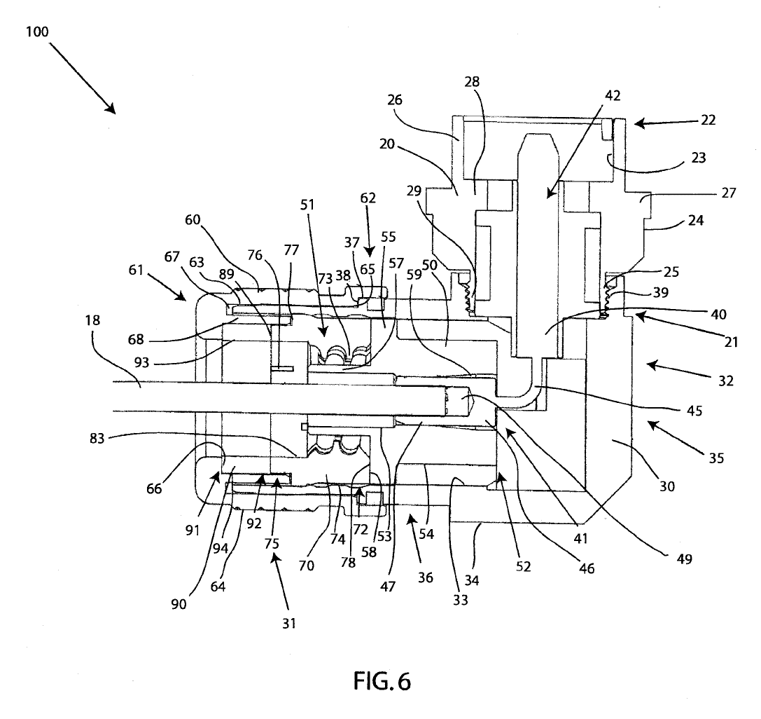

Referring now to FIGS. 1 and FIG. 6, the manner in which connector 100 may move from an open position to a closed position to clamp, seize, and/or compress the coaxial cable 10 is now described. FIG. 1 depicts an embodiment of the connector 100 in an open position. The open position may refer to a position or arrangement wherein the center conductor 18 of the coaxial cable 10 is not clamped or captured by the socket 46 of contact 40, or only partially/initially clamped or captured by the socket 46. The cable 10 may enter the generally axially opening of the compression member 60 and main body 30, and the outer conductor 14 engages the outer conductor engagement member 70. The outer conductor 14 may mate with the outer conductor engagement member 70. For example, the outer conductor 14 may be threaded onto the outer conductor engagement member 70, or may simply be pushed (axially) further into the main body 30. In some embodiments, the connector 100 may be rotated or twisted to provide the necessary rotational movement of the outer conductor engagement member 70 to mechanically engage, or threadably engage, the outer conductor 14. Alternatively, in other embodiments, the coaxial cable 10 may be rotated or twisted to provide the necessary rotational movement of the outer conductor engagement member 70 to mechanically engage, or threadably engage, the outer conductor 14. The engagement between the outer conductor 14 and the outer conductor engagement member 70 may establish a mechanical connection between the connector 100 and the coaxial cable 10. Those skilled in the art should appreciate that mechanical communication or interference may be established without threadably engaging an outer conductor 14, such as friction fit between the cable 10 and the connector 100.

FIG. 6 depicts an embodiment of a closed position of the connector 100. The closed position may refer to a position or arrangement of the connector 100 wherein the center conductor 18 is fully clamped or accepted by the socket 46 of contact 40, the outer conductor 14 of the coaxial cable 10 is fully clamped, the cable jacket 12 is pinched and secured by the outer conductor engagement member 70, or a combination thereof. The closed position may be achieved by axially compressing the compression member 60 onto the main body 30. For instance, the second end 62 of the compression member 60 may extend an axial distance so that, when the compression member 60 is compressed into a sealing position on the coaxial cable 100, the compression member 60 may touch or reside proximate or otherwise near the first portion 35 of the main body 30. The axial movement of the compression member 60 can axially displace the cable 10 and other components disposed within the main body 30, such as 50, 70, and 90, because of the mechanical engagement between the inner portion 68 of the compression member 60 and third mating edge 77 of the outer conductor engagement member 70. The outer conductor engagement member 70 may then engage the insulator body 50 to axially displace the insulator body 50 further onto the socket 46, but may also axially displace the cable 10 due to mechanical interference with the outer conductor layer 14. Furthermore, axially displacing the outer conductive engagement member 70 can radially compress the outer conductor engagement member 70 onto the outer conductor 14 and the cable jacket 12. For instance, the slotted outer conductive engagement member 70 may deflect (e.g. radially inward) onto the coaxial cable 10 when the narrowing inner surface 33 of the main body 30 radially constricts the outer conductor engagement member 70 when the connector moves from the open to the closed position. The cantilever action of the recessed portion 75 provides a compressive retention force onto the cable jacket 12 and the deflection of the fingers 75 provides a compressive clamping force onto the outer conductor 14 when the outer conductor engagement member 70 is compressed, preventing unwanted movement and shifting of the cable, thereby obtaining desirable PIM results.

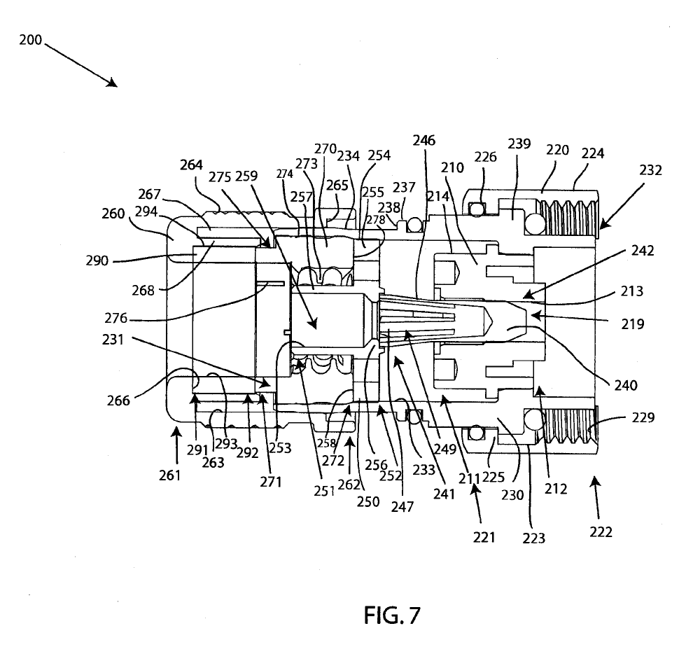

Referring to the drawings, FIG. 7 depicts an embodiment of a connector 200 in an open position. Connector 200 may share the same or similar components and function of connector 100; however, connector 200 may be a straight coaxial cable connector or any complimentary connector or port that may receive a center conductor 18 of a coaxial cable 10. Further embodiments of connector 200 may receive a center conductor 18 of a coaxial cable 10, wherein the coaxial cable 10 includes a corrugated, smoothwall, or otherwise exposed outer conductor 14. Connector 200 can also be provided to a user in a preassembled configuration to ease handling and installation during use.

Embodiments of connector 200 may include a main body 230, a front body 220, a contact 240, an insulator body 250, a contact component 210, an outer conductor engagement member 270, a collar 290, and a compression member 260. Embodiments of the outer conductor engagement member 270, a collar 290, and a compression member 260 described in association with connector 200 may share the same or substantially the same structure and function as described above in association with connector 100. For example, the outer conductor engagement member 270 may include a first end 271, a second end 272, an inner surface 273, an outer surface 274, an annular recessed portion 275, and one or more axial openings 276 to permit deflection to effectively clamp or otherwise seize the cable 10, including the jacket 12 and the outer conductor 14 to achieve desirable PIM results. For instance, the outer conductor engagement member 270 may engage the outer conductor 14 of cable 10 proximate the second end 272, and engage the cable jacket 12 proximate the annular recessed portion 275. Embodiments of the main body 230 and the front body 220 may share similar structural and functional aspects as main body 30 and front body 20, as described supra.

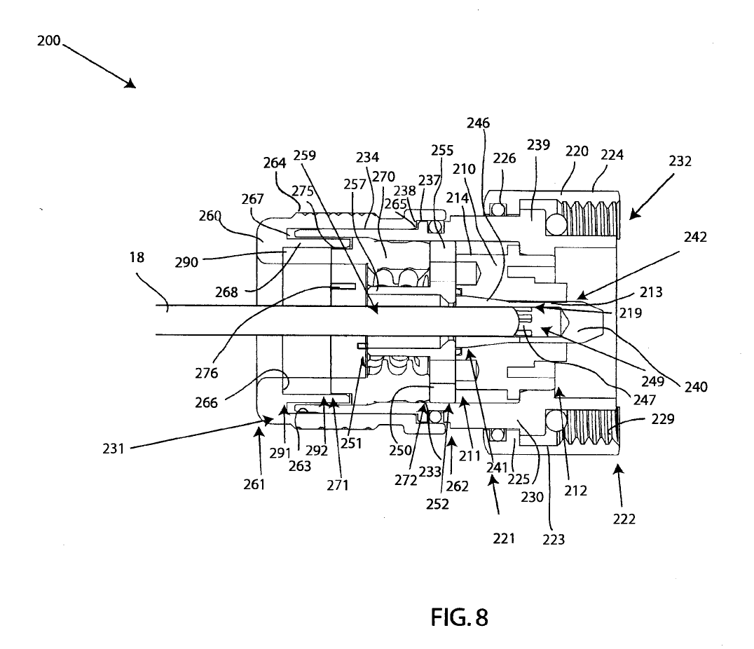

Additionally, the collar 290 may have a first end 291, a second end 292, an inner surface 293, an outer surface 294, and may be an annular tubular member disposed within the main body 230 outer conductor engagement member 270. The compression member 260 may include a first end 261, a second end 262, an inner surface 623, and an outer surface 264, and may be axially displaced to move connector 200 from an open position (shown in FIG. 7) to a closed position (shown in FIG. 8). The compression member 260 may further include a cavity 267 proximate or otherwise near the first end 261. The cavity 267 may be a space, opening, void, and the like, which may be located between the inner surface 263 of the compression member 260 and an inner portion 268. The inner portion 268 may be an annular member which can be parallel to the outer structural surface of the compression member 260.

Embodiments of connector 200 may include a main body 230. Main body 230 may include a first end 231, a second end 232, an inner surface 233, and an outer surface 234. The main body 230 may include a lip 239 for limiting axial movement of a front body 220 (e.g. coupling member) disposed around the main body 230 proximate or otherwise near the second end 232. Similar to the opening of the main body 30, embodiments of main body 230 may have an internal geometry that facilitates the compression of the outer conductor engagement member 70 as the connector 200 moves to a closed position. The generally axial opening of the main body 230 may extend from proximate the first end 231 and through the second end 232 of the main body 230. The generally axial opening of the second portion 236 of the main body 230 may have an internal diameter large enough to allow an insulator body 250, an outer conductor engagement member 270, a collar 290, and portions of a coaxial cable 10 to enter and remain disposed within the main body 230 while operably configured. While disposed within the main body 230, the outer conductor engagement member 270, and other internal components, may be radially compressed by the inner surface 233 of the main body 230, similar to the compression described in association with connector 100. Embodiments of the main body 230 may include an annular protrusion 237 which may protrude or extend a distance from the outer surface 234 of the main body 230. The annular protrusion 237 may include a mating edge 238 (i.e. a face/side of the annular protrusion 237 which faces the first end 231 of the main body 230) that can mate with a mating edge, such as annular recessed portion 265 of a compression member 260 while in a closed position. In addition, the main body 230 may be formed of metals or polymers or other materials that would facilitate a rigidly formed body. Manufacture of the main body 230 may include casting, extruding, cutting, turning, tapping, drilling, injection molding, blow molding, or other fabrication methods that may provide efficient production of the component. Those in the art should appreciate that various embodiments of the main body 230 may also comprise various inner or outer surface features, such as annular grooves, detents, tapers, recesses, and the like, and may include one or more structural components having insulating properties located within the main body 230.

Referring still to FIG. 7, embodiments of connector 200 may include a front body 220. The front body 220 may include a first end 221, a second end 222, an inner surface 223, and an outer surface 224. The front body 220 may disposed proximate or otherwise near the second end 232 of the main body 230, and may achieve rotational movement about the main body 230. Embodiments of the front body 220 may include a generally axial opening extending from the first end 221 to the second end 222. Proximate or otherwise near the first end 221 of the front body 220 may be an annular lip 225. The annular lip 225 may engage the lip 239 of the main body 230, which may hinder axial movement of the front body 220. Disposed on the internal surface 223 proximate or otherwise near the second end 222 of the front body 220 may be a threaded portion 229 for threadably engaging, securably affixing to, or mating with a corresponding cable interface port or a corresponding coaxial cable connector. Moreover, the front body 220 may include an annular recessed portion 226 proximate or otherwise near the first end 221 to accommodate an O-ring or other resilient member. The front body 220 may also be a coupling member having internal threads, configured to connect, accommodate, receive, or couple with an additional coaxial cable connector. In addition, the front body 220 may be formed of metals or polymers or other materials that would facilitate a rigidly formed body. Manufacture of the front body 220 may include casting, extruding, cutting, turning, tapping, drilling, injection molding, blow molding, or other fabrication methods that may provide efficient production of the component. Those in the art should appreciate that various embodiments of the front body 220 may also comprise various inner or outer surface features, such as annular grooves, detents, tapers, recesses, and the like, and may include one or more structural components having insulating properties located within the front body 220.

With continued reference to FIG. 7, embodiments of connector 200 may include a contact 240. Contact 240 may include a first end 241 and a second end 242 and may be disposed within the main body 230. Contact 240 may be a conductive element that may extend or carry an electrical current and/or signal from a first point to a second point. Contact 240 may be a terminal, a pin, a conductor, an electrical contact, and the like. Furthermore, contact 240 may be both female and male, and should be formed of conductive materials.

Embodiments of contact 240 may include a socket 246 proximate or otherwise near the first end 241. The socket 246 may be a conductive center conductor clamp or basket that clamps, grips, collects, or mechanically compresses onto the center conductor 18. The socket 246 may further include an opening 249, wherein the opening 249 may be a bore, hole, channel, and the like; the socket 246, in particular, the opening 249 of the socket 246 may accept, receive, and/or clamp an incoming center conductor 18 of the coaxial cable 10 as a coaxial cable 10 is further inserted into the main body 230 to achieve a closed position. The socket 246 may include a plurality of engagement fingers 247 that may permit deflection and reduce (or increase) the diameter or general size of the opening 249. In other words, the socket 246 of contact 240 may be slotted or otherwise resilient to permit deflection of the socket 246 as the coaxial cable 10 is further inserted into the main body 230 to achieve a closed position, or as the compression member 260 is axially displaced further onto main body 230. In an open position, or prior to full insertion of the coaxial cable 10, the plurality of engagement fingers 247 may be in a spread open configuration, or at rest, to efficiently engage, collect, capture, etc., the center conductor 18 and engage with the insulator body 250

Referring still to FIG. 7, embodiments of connector 200 may include an insulator body 250. The insulator body 250 may include a first end 251, a second end 252, an internal surface 253, and an outer surface 254. The insulator body 250 may be disposed within the main body 230. For example, the insulator body 250 may be disposed or otherwise located in the generally axial opening of the main body 230. The insulator body 250 may further include an opening 259 extending axially through the insulator body 250 from the first end 251 through the second end 252. The opening 259 may be a bore, hole, channel, tunnel, and the like. The insulator body 250, in particular, the opening 259 of the insulator body 50 may accept, receive, accommodate, etc., an incoming center conductor 18 of the coaxial cable 10 as a coaxial cable 10 is further inserted into the main body 230. The diameter or general size of the opening 259 should be large enough to accept the center conductor 18 of the coaxial cable 10, but may be slightly smaller proximate the point of engagement with the socket 246 of contact 240 to mechanically engage the fingers 247 of socket 246. Proximate the second end 252, the insulator body 250 may include an internal lip 256. The internal lip 256 may provide a mating surface for socket 246, and may extend or radially protrude into opening 259 of the insulator body 250. The insulator body 250 may initially engage the plurality of engagement fingers 247, and as the coaxial cable 10 is further inserted into the main body 230, the insulator body 250 may drive or axially displace the contact 240 towards the second end 232 of the main body 230 due to the mechanical interference between the internal lip 256 and the plurality of engagement fingers 247 of the socket 246. As the coaxial cable 10 is further inserted into the main body 230, the internal surface 213 of a contact component 210 disposed within the main body 230 may compress the resilient engagement fingers 247 onto or around the center conductor 18.

Moreover, embodiments of the insulator body 250 may include an annularly extending protrusion 255 which may protrude or extend a distance from the outer surface 254 of the insulator body 250. The diameter of the flange 255 may be substantially the same or slightly smaller than the diameter of the generally axial opening of the main body 230 to allow axial displacement of the insulator body 250 within the main body 230. The annular protrusion 255 may include a mating edge 258 (i.e. a face/side of the annular protrusion 255 which faces the first end 251 of the insulator body 250) that can mate with a mating edge 278 of an outer conductor engagement member 270, and a portion of the outer conductor 14 as the coaxial cable 10 is advanced through the main body 230. Further embodiments of the insulator body 250 may include an annular detent 257 proximate or otherwise near the first end 251 of the insulator body 250. The annular detent 257 may be sized and dimensioned to enter cavity 15 of the coaxial cable 10, wherein the cavity 15 is created when a portion of the dielectric 16 surrounding the center conductor 18 is removed or cored. The annular detent 257 may engage the dielectric 16, in particular a mating edge of the dielectric as the cable 10 is advanced into the main body 230. Thus, the annular detent 257 of the insulator body 250 may be disposed between the outer conductor 14 and the center conductor 18 in a closed position. Furthermore, the insulator body 250 should be made of non-conductive, insulator materials. Manufacture of the insulator body 250 may include casting, extruding, cutting, turning, drilling, compression molding, injection molding, spraying, or other fabrication methods that may provide efficient production of the component.

Embodiments of connector 200 may also include a contact component 210. The contact component 210 may include a first end 211, a second end 212, an inner surface 213, and an outer surface 214. The contact component 210 may be disposed within the main body 230, wherein the contact component 210 surrounds or substantially surrounds at least a portion of contact 240. Moreover, the contact component 210 may include an axially extending opening 219 which may extend from the first end 211 through the second end 212. The opening 219 may be a bore, hole, channel, tunnel, and the like. The contact component 210, in particular, the opening 219 of the contact component 210 may accept, receive, accommodate, etc., the axially displaced electrical contact 240 and center conductor 18 of the coaxial cable 10 as a coaxial cable 10 is further inserted into the main body 230.

Referring now to FIG. 7 and FIG. 8, the manner in which connector 200 may move from an open position to a closed position is now described. FIG. 7 depicts an embodiment of the connector 200 in an open position. The open position may refer to a position or arrangement wherein the center conductor 18 of the coaxial cable 10 is not clamped or captured by the socket 246 of contact 240, or only partially/initially clamped or captured by the socket 246. The cable 10 may enter the generally axially opening of the compression member 260, and the outer conductor 14 engages the outer conductor engagement member 270. The outer conductor 14 may mate with the outer conductor engagement member 270. For example, the outer conductor 14 may be threaded onto the outer conductor engagement member 270, or may simply be pushed (axially) further into the main body 230. In some embodiments, the connector 200 may be rotated or twisted to provide the necessary rotational movement of the outer conductor engagement member 270 to mechanically engage, or threadably engage, the outer conductor 14. Alternatively, in other embodiments, the coaxial cable 10 may be rotated or twisted to provide the necessary rotational movement of the outer conductor engagement member 270 to mechanically engage, or threadably engage, the outer conductor 14. The engagement between the outer conductor 14 and the outer conductor engagement member 270 may establish a mechanical connection between the connector 200 and the coaxial cable 10. Those skilled in the art should appreciate that mechanical communication or interference may be established without threadably engaging an outer conductor 14, such as friction fit between the cable 10 and the connector 100.

FIG. 8 depicts an embodiment of a closed position of the connector 200. The closed position may refer to a position or arrangement of the connector 200 wherein the center conductor 18 is fully clamped or accepted by the socket 246 of contact 240. The closed position may be achieved by axially compressing the compression member 260 onto the main body 230. For instance, the second end 262 of the compression member 260 may extend an axial distance so that, when the compression member 260 is compressed into a sealing position on the coaxial cable 10, the compression member 260 may touch or reside proximate or otherwise near the front body 220. The axial movement of the compression member 260 can axially displace the cable 10 and other components disposed within the main body 230, such as 250, 270, and 290, because of the mechanical engagement between the inner portion 68 of the compression member 60 and the outer conductor engagement member 70 (or the lip 266 of the compression member 260 and the collar 290). The outer conductor engagement member 270 may then engage the insulator body 250 to axially displace the insulator body 250 into engagement with the socket 246, but may also axially displace the cable 10 due to mechanical interference with the outer conductor 14. As described supra, the axial movement of the insulator body causes axial displacement of the contact 240 into the opening 219 of the contact component 210. Furthermore, axially displacing the outer conductive engagement member 270 can radially compress the outer conductor engagement member 720 onto the outer conductor 14 and the cable jacket 12. For instance, the slotted outer conductive engagement member 270 may deflect (e.g. radially inward) onto the coaxial cable 10 when the narrowing inner surface 233 of the main body 230 radially constricts the outer conductor engagement member 270 when the connector moves from the open to the closed position. The cantilever action of the recessed portion 275 provides a compressive retention force onto the cable jacket 12 and the deflection of the fingers 275 provides a compressive clamping force onto the outer conductor 14 when the outer conductor engagement member 270 is compressed, preventing unwanted movement and shifting of the cable, thereby obtaining desirable PIM results.

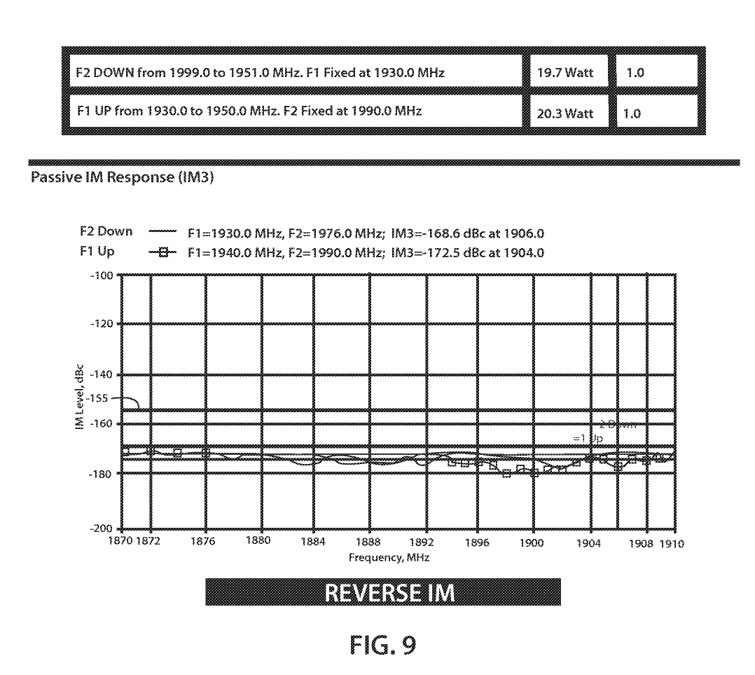

FIG. 9 discloses a chart showing the results of PIM testing performed on the coaxial cable 10 that was terminated using the example compression connector 100, 200. The particular test used is known to those having skill in the requisite art as the International Electrotechnical Commission (IEC) Rotational Test. The PIM testing that produced the results in the chart was also performed under dynamic conditions with impulses and vibrations applied to the example compression connector 100, 200 during the testing. As disclosed in the chart, the PIM levels of the example compression connector, 100, 200 were measured on signals F2 UP and F2 DOWN to vary significantly less across frequencies 1870-1910 MHz. Further, the PIM levels of the example compression connector 100, 200 remained well below the minimum acceptable industry standard of −155 dBc. For example, F1 UP achieved an intermodulation (IM) level of −172.5 dBc at 1907 Mhz, while F2 DOWN achieved an intermodulation (IM) level of −168 dBc at 1906 Mhz. These superior PIM levels of the example compression connector 100, 200 are due at least in part to the clamping of the coaxial cable 10 when the connector in the closed position, as described supra.

Compression connectors having PIM levels above this minimum acceptable standard of −155 dBc result in interfering RF signals that disrupt communication between sensitive receiver and transmitter equipment on the tower and lower-powered cellular devices in 4G systems. Advantageously, the relatively low PIM levels achieved using the example compression connector 100, 200 surpass the minimum acceptable level of −155 dBc, thus reducing these interfering RF signals. Accordingly, the example field-installable compression connector 100, 200 enables coaxial cable technicians to perform terminations of coaxial cable in the field that have sufficiently low levels of PIM to enable reliable 4G wireless communication. Advantageously, the example field-installable compression connector 100, 200 exhibits impedance matching and PIM characteristics that match or exceed the corresponding characteristics of less convenient factory-installed soldered or welded connectors on pre-fabricated jumper cables. Accordingly, embodiments of connector 100, 200 may be a compression connector, wherein the compression connector achieves an intermodulation level below −155 dBc over a frequency of 1870 MHz to 1910 MHz.

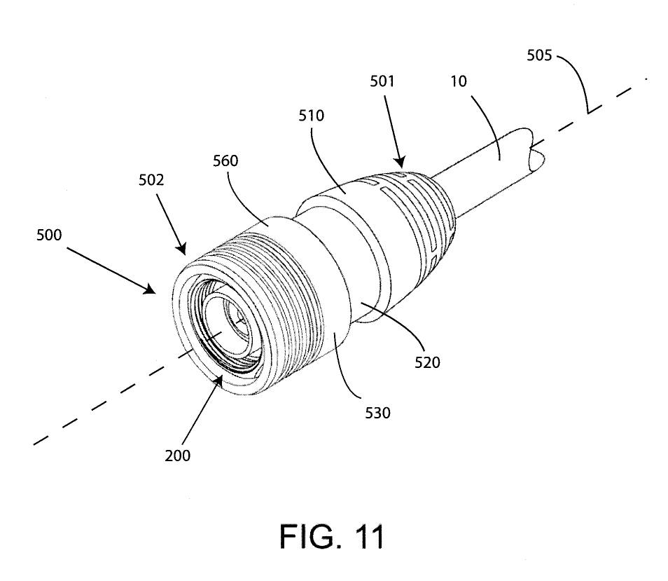

With continued reference to the drawings, FIGS. 11 and 12 depict an embodiment of connector 200 having a cover 500. FIG. 11 depicts an embodiment of connector 200 having a cover 500 in a first position. FIG. 12 depicts an embodiment of connector 200 having a cover 500 in a second, sealing position. Cover 500 may be a seal, a sealing member, a sealing boot, a sealing boot assembly, and the like, that may be quickly installed and/or removed over a connector, such as connector 200, and may terminate at a bulkhead of a port or at a sliced connection with another coaxial cable connector of various sizes/shapes. Cover 500 can protect the cable connectors or other components from the environment, such as moisture and other environmental elements, and can maintain its sealing properties regardless of temperature fluctuations. Embodiments of cover 500 may be a cover for a connector 200 adapted to terminate a cable 10, wherein the cover 500 comprises an elongated body 560 comprising a cable end 501 and a coupler end 502, an interior surface 503 and an exterior surface 504, wherein the elongated body 560 extends along a longitudinal axis 505. The interior surface 503 can include a first region 510 adapted to cover at least a portion of the cable 10 and can extend from the cable end 501 to a first shoulder, wherein the first region is of a minimum, first cross-sectional diameter. The interior surface 503 may further include a second region 520 which is adapted to cover at least the connector body portion 550 and which may extend from the first shoulder to a second shoulder. The second region 520 may have a minimum, second cross-sectional diameter that is greater than the minimum, first cross-sectional diameter. The interior surface 503 may further include a third region 530 which is adapted to cover at least a portion of the connector 200 and which extends from the second shoulder to the coupler end 502. The third region 530 may have a minimum, third cross-sectional diameter that is greater than the minimum, second cross-sectional diameter. Further embodiments of the cover 500 may include a plurality of circumferential grooves 515 to provide strain relief as the cover moves from the first position to the second position. The circumferential grooves 515 can extend less than completely around the circumference of the first region 510 of cover 500. Furthermore, embodiments of the cover 500 may comprise an elastomeric material that maintains its sealing abilities during temperature fluctuations. In one embodiment, the cover 500 is made of silicone rubber.

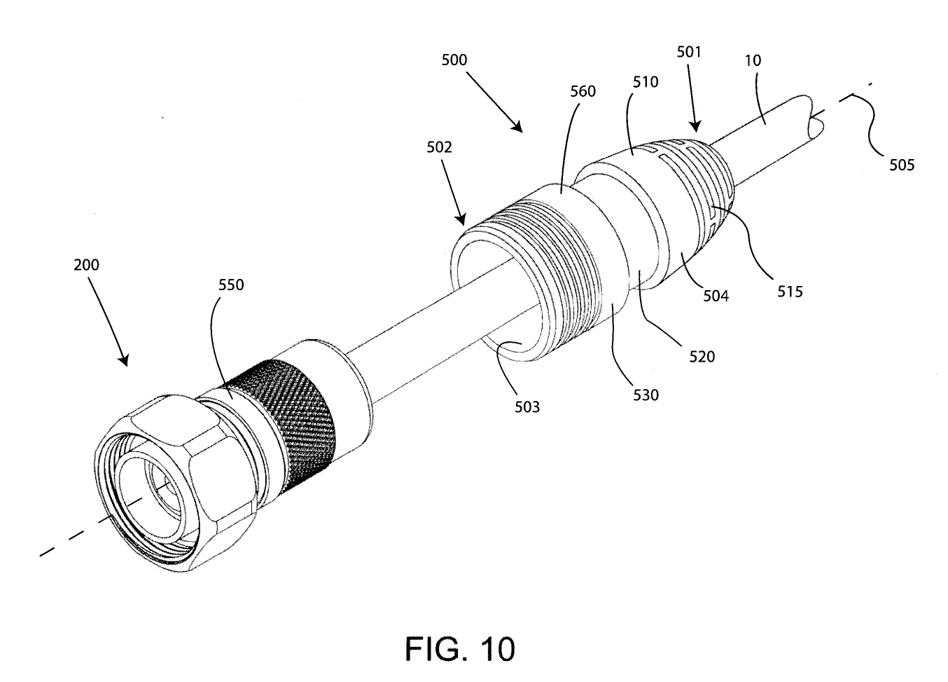

Referring now to FIGS. 1-13, a method of clamping a coaxial cable 10 may include the steps of providing a connector 100, 200 including: a main body 30, 230 having a first end 31, 231 and a second end 32, 232, the main body 30, 230 configured to receive a prepared coaxial cable 10, a front body 20, 220 operably attached to the main body 30,230, and an outer conductor engagement member 70, 270 having a first end 71, 271 and a second end 72, 272; and slotting the outer conductor engagement member 70, 270 to facilitate deflection of the outer conductor engagement member 70, 270 to clamp the coaxial cable 10.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. An outer conductor engagement member comprising:
an annular member having a first end and a second end, the annular member including an annular recessed portion proximate the first end, wherein the annular member is disposed within a main body of a coaxial cable connector; and
at least one axial opening on the annular member extending in a first direction from proximate the second end through the first end to facilitate radially inward deflection of the annular recessed portion to compress a coaxial cable jacket of a received coaxial cable.

2. The outer conductor engagement member of claim 1, further comprising at least one axial opening on the annular member extending in a second direction from proximate the first end through the second end to permit radially inward deflection of the annular member proximate the second end to clamp a rigid outer conductor of the received coaxial cable.

3. The outer conductor engagement member of claim 1, wherein the annular member is made of conductive materials.

4. The outer conductor engagement member of claim 1, wherein the annular member includes an inner surface having a grooved portion, the grooved portion corresponding to an outer surface of an outer conductor.

5. The outer conductor engagement member of claim 4, wherein the grooved portion corresponds to a helical outer surface of the outer conductor.

6. A connector comprising:
a main body having a first end and a second end, the main body configured to receive a prepared coaxial cable;
a compression member configured for axial movable engagement with the main body; and
an outer conductor engagement member having a first end and a second end, the outer conductor engagement member having at least one axial slot to permit deflection of the outer conductor engagement member;
wherein deflection of the outer conductor engagement member clamps the coaxial cable.

7. The connector of claim 6, wherein deflection of the outer conductor engagement member proximate the second end clamps an outer conductor of the coaxial cable.

8. The connector of claim 6, wherein deflection of the outer conductor engagement member proximate the first end compresses an outer jacket of the coaxial cable.

9. The connector of claim 6, wherein deflection of the outer conductor engagement member is in a radially inward direction.

10. The connector of claim 6, further comprising:
an electrical contact having a socket, the socket disposed within the main body and configured to receive a center conductor of the coaxial cable; and
an insulator body disposed within the main body, the insulator body having a first end and a second end.

11. The connector of claim 6, wherein a collar is disposed proximate the outer conductor engagement member to form a seal around the coaxial cable.

12. The connector of claim 6, wherein the outer conductor engagement member includes an annular recessed portion proximate the first end, wherein the annular recessed portion has a reduced outer diameter.

13. The connector of claim 6, wherein an inner surface of the outer conductor engagement member includes a grooved portion proximate the second end, wherein the grooved portion corresponds to an outer surface of the outer conductor of the coaxial cable.

14. The connector of claim 13, wherein the grooved portion corresponds to a helical outer surface of the outer conductor.

15. The connector of claim 6, wherein the compression member includes an inner portion configured to engage a mating edge of the outer conductor engagement member to move the connector from an open position to a closed position.

16. A connector comprising:
a main body having a first end and a second end, the main body configured to receive a prepared coaxial cable;
a compression member configured for axial movable engagement with the main body; and
a means to clamp the coaxial cable and an outer conductor of the coaxial cable;
wherein the means is operable via axial compression of the compression member.

17. The connector of claim 16, wherein the means is conductive.

18. A method of clamping a coaxial cable, comprising:
providing a connector including:
a main body having a first end and a second end, the main body configured to receive a prepared coaxial cable;
a compression member configured for axial movable engagement with the main body; and
an outer conductor engagement member having a first end and a second end; and
slotting the outer conductor engagement member to facilitate deflection of the outer conductor engagement member to clamp the coaxial cable.

19. The method of claim 18, wherein deflection of the outer conductor engagement member proximate the second end clamps an outer conductor of the coaxial cable.

20. The method of claim 18, wherein deflection of the outer conductor engagement member proximate the first end compresses an outer jacket of the coaxial cable.

21. The method of claim 18, wherein deflection of the outer conductor engagement member is in a radially inward direction.

22. The method of claim 18, wherein the connector further comprises:
an electrical contact having a socket, the socket disposed within the main body and configured to clamp a center conductor of the coaxial cable; and
an insulator body disposed within the main body, the insulator body having a first end and a second end.

23. The method of claim 18, further comprising:
disposing a collar proximate the outer conductor engagement member to form a seal around the coaxial cable when the connector is in a closed position.

24. The method of claim 18, further comprising:
axially compressing the connector into a closed position from an open position, wherein the axial compression is achieved through displacement of the compression member with respect to the main body.

25. A device configured to be operably affixed to a coaxial cable comprising:
a compression connector, wherein the compression connector is configured to attach to the cable by the compression of at least one axially slidably movable component of the connector;
wherein the compression connector achieves an intermodulation level below −155 dBc.

26. The device of claim 25, wherein the compression connector includes:
a main body configured to receive a prepared coaxial cable;
a compression member configured for axial movable engagement with the main body; and
an outer conductor engagement member having at least one axial slot to permit deflection of the outer conductor engagement member.

27. The device of claim 25, wherein the compression connector achieves an intermodulation level below −165 at approximately 1905 MHz.

28. The device of claim 25, wherein the intermodulation level of the compression connector is determined according to the IEC Rotational Test Standard.

29. A coaxial cable connector comprising:
a main body configured to receive a coaxial cable;
a compression member configured for axial movable engagement with the main body;
an outer conductor engagement member having an annular recessed portion, wherein deflection of the outer conductor engagement member clamps the coaxial cable; and
a cover disposed over at least a portion of the connector to seal the connector against environmental elements.

30. The coaxial cable connector of claim 29, wherein the cover is an elastomeric material configured to be quickly removed and installed.

31. The coaxial cable connector of claim 29, wherein the outer conductor engagement member includes at least one slot to permit deflection of the outer conductor engagement member onto an outer conductor of the coaxial cable and a jacket of the coaxial cable.

32. The connector of claim 29, further comprising:
an electrical contact having a socket, the socket disposed within the main body and configured to receive a center conductor of the coaxial cable; and
an insulator body disposed within the main body, the insulator body having a first end and a second end.
